(19) United States
(12) Patent Application Publication
(10) Pub. No.: US 2014/0161275 A1
(43) Pub. Date: Jun. 12, 2014

(54) INSERTED TYPE POWER RECEPTACLE APPARATUS

(71) Applicant: RAYMOND WAI-MAN MAK, Hong Kong (HK)

(72) Inventor: RAYMOND WAI-MAN MAK, Hong Kong (HK)

(21) Appl. No.: 13/754,838

(22) Filed: Jan. 30, 2013

(30) Foreign Application Priority Data
Dec. 10, 2012 (CN) 201210528683.9

(51) Int. Cl. H04R 1/02

(52) U.S. Cl. CPC H04R 1/028
USPC 381/77

(57) ABSTRACT

An inserted type power receptacle apparatus includes a main body and an inserted pole connecting with the main body. The main body includes a power input module; a power output module connecting with the power input module and arranged for connecting to a peripheral equipment; a transformer connecting with the power input module; a wireless connecting module for receiving a wireless signal with voice message; a controller connecting with the transformer and the wireless connecting module respectively for receiving the wireless connecting signal and converting to audio-frequency signal; and a loudspeaker connecting with the controller for playing the audio-frequency signal. The present invention can communicate with the wireless signal if of the mobile terminal so as to play voice, such as music according to the wireless signal, thereby improving a better user experience and improving amusement and practicality.

### RELATED APPLICATIONS

This application claims the benefit of priority to Chinese Patent Application No. 201210528683.9 filed in Dec. 10, 2012, which is hereby incorporated by reference in its entirety.

### FIELD OF THE INVENTION

The present invention relates to a power receptacle apparatus, more particularly to an inserted type power receptacle apparatus for inserting into the ground or mounting on a supporter outdoors.

### BACKGROUND OF THE INVENTION

Currently, a power receptacle with extended wire is commonly utilized to provide electricity at outdoor situation such as courtyard. When in use, the power receptacle with extended wire is hung on a branch or a supporter, or placed on the ground directly. Such arrangements are inconvenient for using not only, and bring serious security risk but also, for example, water on the ground may contact with the plug receptacle to cause electric shock.

To improve the drawbacks, an inserted type power receptacle is developed. The inserted type power receptacle has an inserted pole connected with a main body of the power receptacle for inserting into or mounting on the ground, and a plug receptacle plate mounted on sides of the main body. When the inserted pole is inserted into or mounted on the ground, the main body with the plug receptacle plate is apart from the ground with a certain distance, therefore water on the ground may not contact with the plug receptacle plate, thereby improving safety and facilitating the users.

However, this inserted type power receptacle could not satisfy users' multiple demands, for example, if users want to enjoy music when using the inserted type power receptacle, extra music player must be needed.

Hence, there is a need to provide an improved inserted type power receptacle apparatus to communicate with mobile terminal to play music, so as to overcome the drawbacks mentioned above,

### SUMMARY OF THE INVENTION

One objective of the present invention is to provide an inserted type power receptacle apparatus, which can communicate with the wireless signal of the mobile terminal to play voice, thereby providing a better user experience and improving amusement and practicality.

To achieve the above objective, an inserted type power receptacle apparatus of the present invention includes a main body and an inserted pole connecting with the main body. The main body includes a power input module; a power output module connecting with the power input module and arranged for connecting to a peripheral equipment; a transformer connecting with the power input module; a wireless connecting module for receiving a wireless signal with voice message; a controller connecting with the transformer and the wireless connecting module respectively for receiving the wireless connecting signal and converting to audio-frequency signal; and a loudspeaker connecting with the controller for playing the audio-frequency signal. In comparison with the prior art, the present invention includes a wireless connecting module for communicating with the wireless signal if of the mobile terminal so as to play voice, such as music according to the wireless signal, thereby improving a better user experience and improving amusement and practicality.

Optionally, the wireless connecting module includes Wireless Personal Area Network (WPAN) connecting module, Wireless Regional Area Network (WRAN) connecting module, Wireless Metropolitan Area Network (WMAN) connecting module, Wireless Local Area Network (WLAN) connecting module, or Wireless Wide Area Network (WWAN) connecting module.

Preferably, the wireless connecting module includes Bluetooth connecting module, WiFi connecting module, 3G connecting module, 2G connecting module, or GPRS connecting module.

As a preferable embodiment, the Bluetooth connecting module includes a Bluetooth switch unit for controlling turning on or shutting of Bluetooth.

Preferably, the controller includes a volume control unit and a Bluetooth indicator light.

Preferably, the main body includes a plurality of plug receptacles connecting with the power output module and arranged for connecting to the peripheral equipment.

Preferably, a turning cover is configured above the plug receptacle to cover the plug receptacle.

Preferably, the main body includes a plug connecting with the power input module.

Preferably, the controller is an integrated chip.

As another preferable embodiment, an insurance device is connected between the power input module and the power output module.

Preferably, the loudspeaker is covered by a waterproof layer.

Alternatively, the inserted pole is adapted for inserting into ground, or mounting or hanging on a supporter.

### BRIEF DESCRIPTION OF THE DRAWINGS

The accompanying drawings facilitate an understanding of the various embodiments of this invention. In such drawings:

FIG. 1 is a perspective view of an inserted type power receptacle apparatus according to one embodiment of the present invention;

FIG. 2 is another perspective view of an inserted type power receptacle apparatus according to one embodiment of the present invention; and

FIG. 3 is a schematic view of the inserted type power receptacle apparatus according to one embodiment of the present invention.

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the present invention is directed to an inserted type power receptacle apparatus which includes a wireless connecting module for communicating with the wireless signal if of the mobile terminal so as to play voice, such as music according to the wireless signal, thereby improving a better user experience and improving amusement and practicality.

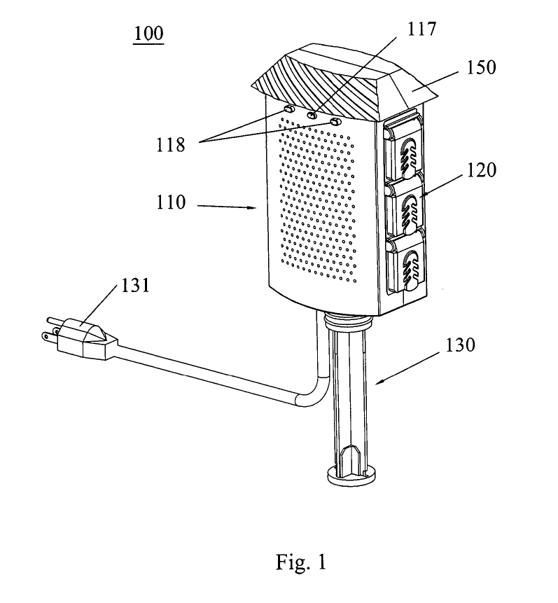

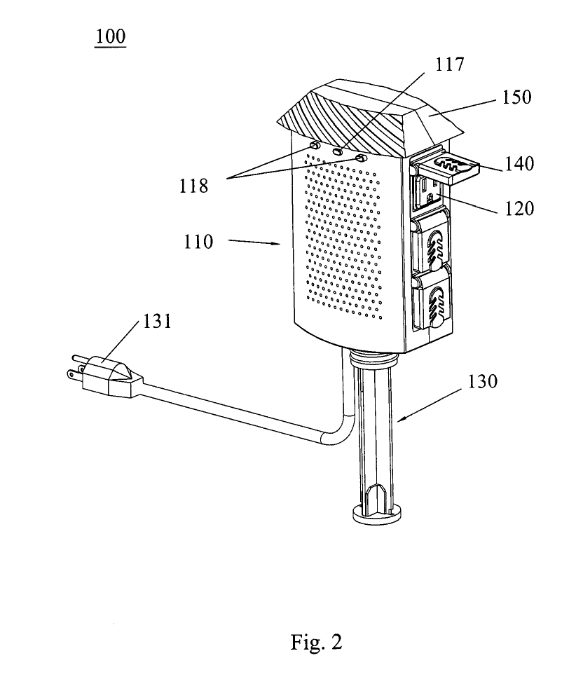

Please refer to FIGS. 1-2, the inserted type power receptacle apparatus 100 according to one embodiment of the present invention includes a main body 110 and an inserted pole 130 connecting with the main body 110 and adapted for inserting into the ground or mounting or hanging on a supporter. Specifically, the main body 110 is shaped cuboid basically. A plug 131 is configured at the lower portion of the main body 110 for connecting with external alternating current, and a plurality of plug receptacles 120 are configured at two sides of the main body 110. Concretely, three plug receptacles 120 are arranged at one side of the main body 110 from top to bottom, and a turning cover 140 is set above each plug receptacle 120 to cover the plug receptacle 120. The turning cover 140 is connected to one side of the main body 110 via a pivotal axis (not shown), thereby opening or closing the turning cover 140. Based on the arrangement of the turning covers 140, the safety of the inserted type power receptacle apparatus 100 is increased significantly, accident such as the rain falls into the plug receptacle 120 or user contacts the plug receptacle 120 can be prevented. Additionally, a top cover 150 is set on the top of the main body, which has inclined planes at circumambience, thereby preventing the rain falling into the plug receptacles 120.

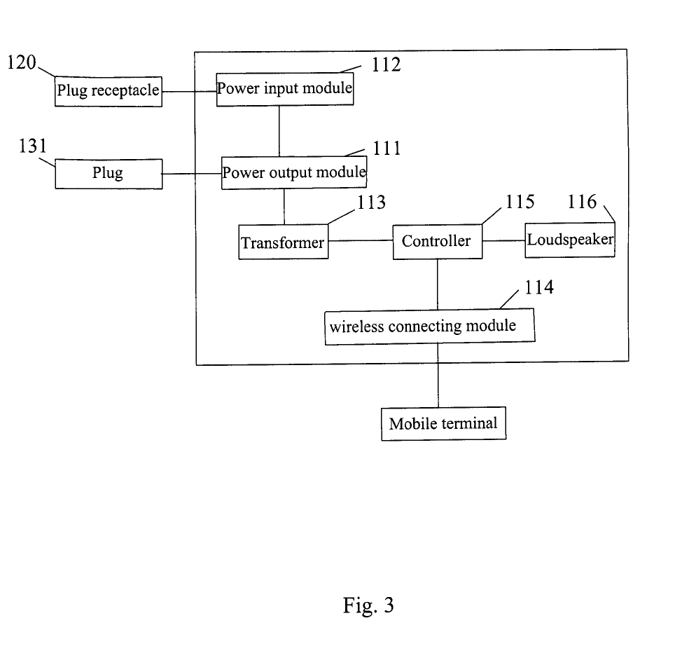

FIG. 3 shows a schematic view of the inserted type power receptacle apparatus 100 according to one embodiment of the present invention. As illustrated, the main body 110 of the inserted type power receptacle apparatus 100 includes a power input module 111 connecting with the plug 131, a power output module 112 connecting with the plug receptacle 120, a transformer 113, a wireless connecting module 114 for receiving a wireless signal, a controller 115 and a loudspeaker 116. Specifically, the transformer 113 is connected with the power input module 111 and the controller 115 respectively, and the wireless connecting module 114 is connected with the mobile terminal. Optionally, the wireless connecting module 114 can be Wireless Personal Area Network (WPAN) connecting module, Wireless Regional Area Network (WRAN) connecting module, Wireless Metropolitan Area Network (WMAN) connecting module, Wireless Local Area Network (WLAN) connecting module, or Wireless Wide Area Network (WWAN) connecting module. For example, the wireless connecting module 114 includes Bluetooth connecting module, WiFi connecting module, 3G connecting module, 2G connecting module, or GPRS connecting module. Thus, the wireless signal can be a Bluetooth signal, WiFi signal, 3G signal, 2G signal or GPRS signal, but not limited here.

In this embodiment, the wireless connecting module 114 is a Bluetooth connecting module, and the mobile terminal is a mobile phone having Bluetooth function. The Bluetooth connecting module matches with a Bluetooth equipment of the mobile phone, so as to receive a Bluetooth signal with voice message. The controller 115 is arranged for playing the voice message according to the Bluetooth signal. The loudspeaker 116 is connected with the controller 115 so as to play the voice message aloud. In the present embodiment, the voice message is a song, for example. Preferably, the controller 115 is an integrated chip. For ensuring a safe using, the inserted type power receptacle apparatus 100 further includes an insurance device (not shown) connected between the power input module 111 and the power output module 112.

Preferably, referring to FIGS. 1-3, the Bluetooth connecting module includes a Bluetooth switch unit for controlling turning on or shutting of Bluetooth, and the Bluetooth switch unit 117 is shaped as button which is protruded from the housing of the main body 110 to facilitate to handle. Concretely, the Bluetooth switch unit 117 will be shut after pressing the button with three seconds when it is turned on. As a preferred embodiment, the controller 115 includes a Bluetooth indicator light (not shown) connected with the Bluetooth switch unit 117, and the color and twinkle time of the Bluetooth indicator light can be arranged according to actual demand so as to distinguish the statuses of Bluetooth, such as turning on, shutting or matching. For example, pressing the Bluetooth switch unit 17 with about three seconds to turn on the Bluetooth switch unit 117, and the Bluetooth switch unit 17 can match with the mobile phone until red light and blue light twinkle of the Bluetooth switch unit 17 alternately. When the Bluetooth of the mobile phone searches and matches with the Bluetooth connecting module of the inserted type power receptacle apparatus 100, the blue light of the Bluetooth indicator light is bright continuously. When the Bluetooth switch unit 117 is shut, the blue light and red light of the Bluetooth indicator light twinkle alternatively for about three seconds in high frequency and then is went out. In this invention, for one mobile phone, if only it connected with the inserted type power receptacle apparatus 100 to play music, there is no need to match with the inserted type power receptacle apparatus 100 again if the mobile phone wants to connect with it again.

As a preferred embodiment, the controller 115 includes a volume control unit 118 connecting with the loudspeaker 116, which is shaped as a button and protrudes from the housing of the main body 110 to facilitate to handle. Concretely, the volume control unit 118 can be designed to be long pressed or short pressed to control the volume, and an alert tone can be configured when volume achieves the minimum or maximum. Preferably, several holes 119 are formed on the housing of the main body 110 at a position opposite the loudspeaker 116, and the loudspeaker 116 is covered by a waterproof layer (not shown).

When users wants the inserted type power receptacle apparatus 100 to play music, the Bluetooth switch unit 117 is turned on so as to make the Bluetooth connecting module of the inserted type power receptacle apparatus 100 stay in activation status. Make sure the Bluetooth of the mobile phone is turned on, and the mobile phone will search the inserted type power receptacle apparatus 100 and match with it. Now the Bluetooth indicator light appears constant blue light. Specifically, the mobile phone sends out a Bluetooth connecting signal, and the Bluetooth connecting module receives the Bluetooth connecting signal and finishes the matching. And then, the Bluetooth connecting module receives a Bluetooth signal having music data from the mobile phone, and the Bluetooth signal with music data will be converted to audio-frequency signal which will be played by the loudspeaker 116 subsequently. The inserted type power receptacle apparatus 100 of the present invention provides a better user experience, and improves amusement and practicality.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An inserted type power receptacle apparatus comprising a main body and an inserted pole connecting with the main body, the main body comprising:
a power input module;
a power output module connecting with the power input module and arranged for connecting to a peripheral equipment;
a transformer connecting with the power input module;
a wireless connecting module for receiving a wireless signal with voice message;
a controller connecting with the transformer and the wireless connecting module respectively for receiving the wireless connecting signal and converting to audio-frequency signal; and
a loudspeaker connecting with the controller for playing the audio-frequency signal.

2. The inserted type power receptacle apparatus according to claim 1, wherein the wireless connecting module comprises Wireless Personal Area Network (WPAN) connecting module, Wireless Regional Area Network (WRAN) connecting module, Wireless Metropolitan Area Network (WMAN) connecting module, Wireless Local Area Network (WLAN) connecting module, or Wireless Wide Area Network (WWAN) connecting module.

3. The inserted type power receptacle apparatus according to claim 1, wherein the wireless connecting module comprises Bluetooth connecting module, WiFi connecting module, 3G connecting module, 2G connecting module, or GPRS connecting module.

4. The inserted type power receptacle apparatus according to claim 3, wherein the Bluetooth connecting module comprises a Bluetooth switch unit for controlling turning on or shutting of Bluetooth.

5. The inserted type power receptacle apparatus according to claim 1, wherein the controller comprises a volume control unit.

6. The inserted type power receptacle apparatus according to claim 4, wherein the controller comprises a Bluetooth indicator light.

7. The inserted type power receptacle apparatus according to claim 1, wherein the main body comprises a plurality of plug receptacles connecting with the power output module and arranged for connecting to the peripheral equipment.

8. The inserted type power receptacle apparatus according to claim 7, wherein a turning cover is configured above the plug receptacle to cover the plug receptacle.

9. The inserted type power receptacle apparatus according to claim 1, wherein the main body comprises a plug connecting with the power input module.

10. The inserted type power receptacle apparatus according to claim 1, wherein the controller is an integrated chip.

11. The inserted type power receptacle apparatus according to claim 1, wherein an insurance device is connected between the power input module and the power output module.

12. The inserted type power receptacle apparatus according to claim 1, wherein the loudspeaker is covered by a waterproof layer.

13. The inserted type power receptacle apparatus according to claim 1, wherein the inserted pole is adapted for inserting into ground, or mounting or hanging on a supporter.
